(19) United States
(12) Patent Application Publication
(10) Pub. No.: US 2007/0097689 A1
(43) Pub. Date: May 3, 2007

(54) Docking station lamp for portable electronic devices

(75) Inventors: Sasha I. Barausky, Baltimore, MD (US); Peter D. Cozzolino, Baltimore, MD (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Blackstone International LTD.

(21) Appl. No.: 11/528,719

(22) Filed: Sep. 26, 2006

Related U.S. Application Data
(60) Provisional application No. 60/721,680, filed on Sep. 29, 2005.

(51) Int. Cl. F21S 8/08

(52) U.S. Cl. 362/287; 362/410

(57) ABSTRACT

A full spectrum desk lamp is configured with a universal docking station built into the base of the lamp for charging battery operated portable electronic devices. The charging module for the portable electronic device is plugged into a commercial electrical power outlet provided at the back of the base of the lamp. The charger cord plug end is snaked through a groove in the base of the lamp and up through a passage into the docking station well for access and connection to a portable electronic device placed in the well of the docking station. A tool may be used to help pass the cord plug end up through the base of the lamp.

### CROSS REFERENCE TO RELATED APPLICATION

Reference is made to and priority claimed from U.S. provisional application Ser. No. 60/721,680, filed Sep. 29, 2005, entitled DOCKING STATION LAMP FOR PORTABLE ELECTRONIC DEVICES.

### TECHNICAL FIELD

The present invention relates generally to portable electronic devices and deals more particularly with a docking station lamp for portable electronic devices.

### BACKGROUND OF THE INVENTION

Portable electronic devices are becoming more and more sophisticated providing for example, communications, entertainment, personal assistance, music, and other functions, which users have come to rely on as a part of their daily routine. As such, the portable electronic devices require their batteries to be recharged from time-to-time. It would be desirable to be able to recharge the batteries and at the same time operate the portable electronic device for communications, entertainment, personal assistance, music, and other such functions in a convenient manner for example while at a desk without adding clutter, wiring or other ancillary devices to the work surface. It would also be desirable to illuminate the work surface with a full spectrum light for reading, writing, drawing, hobbies and other tasks requiring a well-lit surface. What is needed is a convenient way to recharge and operate a portable electronic device and at the same time provide full spectrum illumination on a work surface.

### SUMMARY OF THE INVENTION

In accordance with a broad aspect of the invention, a full spectrum desk lamp is configured with a universal docking station built into the base of the lamp for charging a battery operated portable electronic device. A commercial electrical power outlet is provided at the back of the base of the lamp into which the charging module for the portable electronic device is plugged. The charger cord plug end that is operatively connected to the portable electronic device is snaked through a groove in the base of the lamp and up through a passage into the docking station well for access and connection to the portable electronic device placed in the well of the docking station. A tool may be used to help pass the cord plug end up through the base of the lamp.

In another aspect of the invention, the docking station is configured with suitable speakers for operative connection to the portable electronic device in the docking station for providing audio originating from the portable electronic device.

In another aspect of the invention, the docking station is configured with a suitable microphone for operative connection to the portable electronic device in the docking station for coupling an input audio such as voice to the portable electronic device.

In a further aspect of the invention, the docking station is configured with a suitable FM transmitter for operative connection to the portable electronic device in the docking station for transmitting an FM signal of an audio signal for example originating at the portable electronic device.

### BRIEF DESCRIPTION OF DRAWINGS

Other features of the present invention will become readily apparent to those skilled in the art from the following description taken in conjunction with the drawings wherein:

FIG. 1 is a front elevation schematic view showing the docking station lamp in a first example of the invention.

FIG. 2 is a rear elevation schematic view of the docking station lamp shown in FIG. 1.

FIG. 3 is a side elevation schematic view of the docking station lamp shown in FIGS. 1 and 2.

FIG. 4 is a top plan schematic view of the docking station lamp shown in FIGS. 1, 2 and 3.

FIG. 5 is a front elevation schematic view showing the docking station lamp in another example of the invention in which speakers and a microphone are added to the base.

FIG. 6 is a rear elevation schematic view of the docking station lamp shown in FIG. 5.

FIG. 7 is a side elevation schematic view of the docking station lamp shown in FIGS. 5 and 6.

FIG. 8 is a top plan schematic view of the docking station lamp shown in FIGS. 5, 6 and 7.

FIG. 9 is a front elevation schematic view showing the docking station lamp in another example of the invention in which a suitable FM transmitter is added to the base.

FIG. 10 is a rear elevation schematic view of the docking station lamp shown in FIG. 9.

FIG. 11 is a side elevation schematic view of the docking station lamp shown in FIGS. 9 and 10.

FIG. 12 is a top plan schematic view of the docking station lamp shown in FIGS. 9, 10 and 11.

FIG. 13 is a top plan schematic view of the lampshades in a side-by-side orientation in the docking station lamp of the invention.

FIG. 14 is a top plan schematic view of the lampshades rotated to a 180° orientation from their side-by-side orientation as shown in FIG. 13.

FIG. 15 is a front schematic plan view of the lampshades shown in FIG. 13.

FIG. 16 is a bottom schematic plan view of the docking station lamp base showing a groove for receiving the cord of a charging module.

FIG. 17 shows a tool as it might be used in pulling the plug of the charging module cord into position in the well of the docking station in the base of the lamp.

FIG. 18 shows schematically the plug of the charging module cord in position for operative connection to a portable electronic device placed in the well of the docking station.

FIG. 19 is a schematic block diagram showing the interconnection between major functional components of one example of the docking station lamp embodying the present invention.

### WRITTEN DESCRIPTION OF THE INVENTION

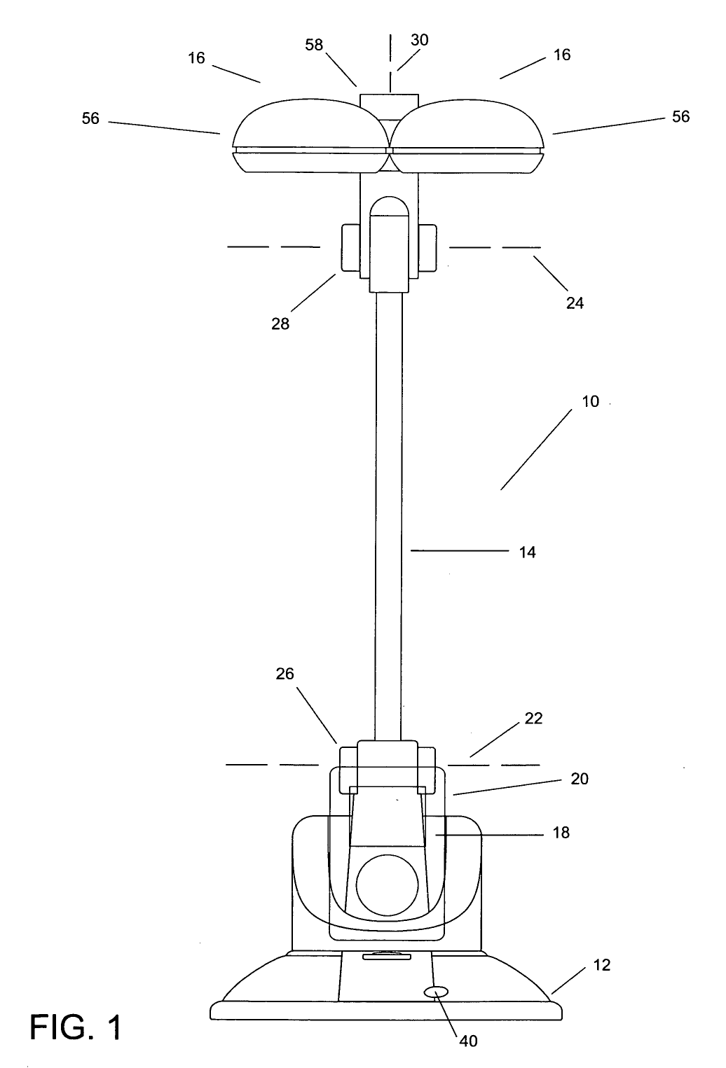

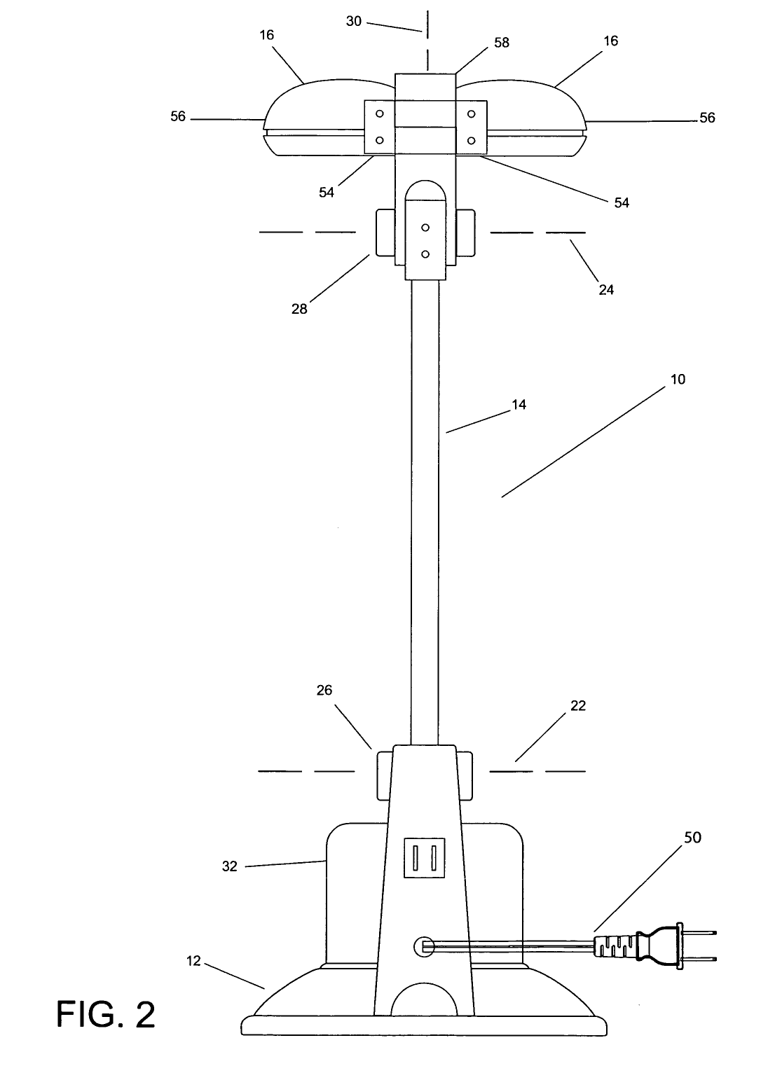

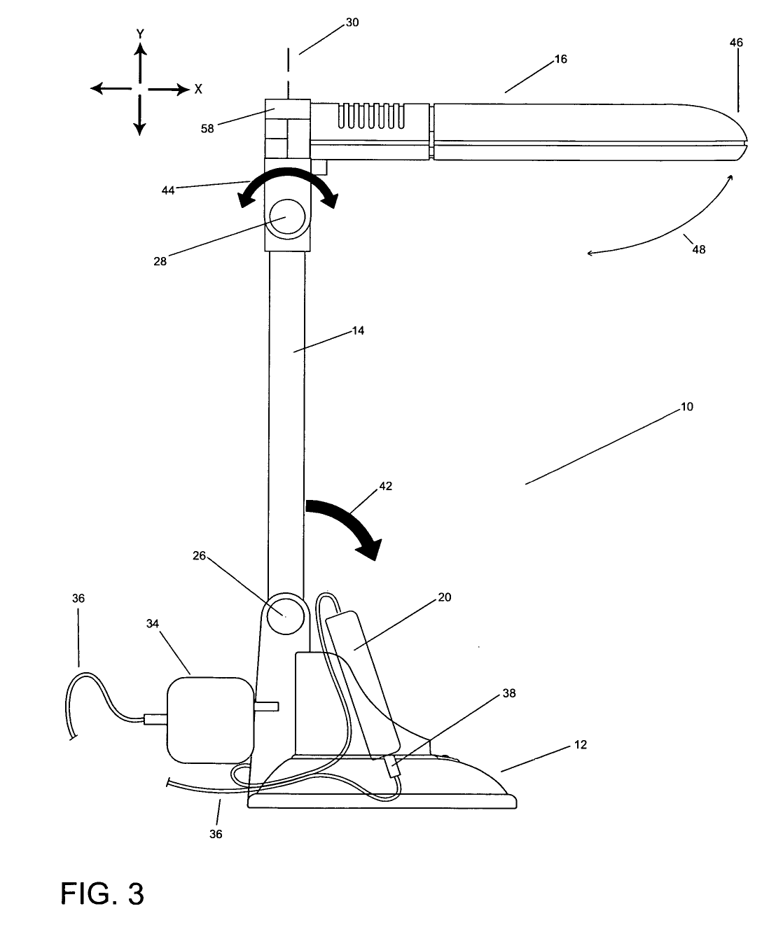

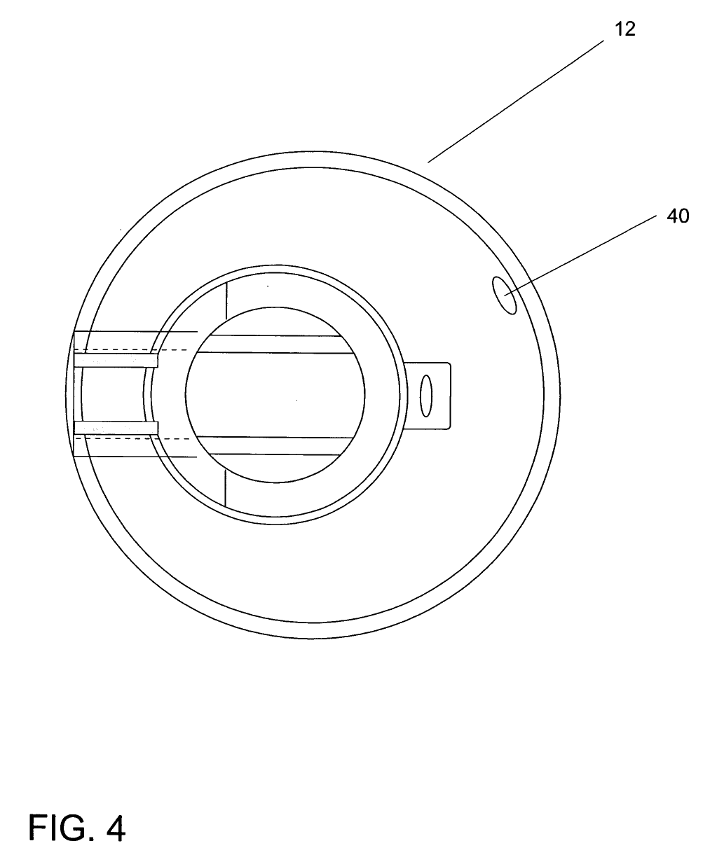

Turning now to the drawings and considering the invention in greater detail, a first example of the docking station lamp embodying the invention is shown in FIGS. 1-4 and generally designated 10. The docking station lamp 10 includes a base 12, an arm 14 extending generally outward from the base 12 and at least one illumination source such as a lamp 16 which may also be referred to as a lampshade herein held by the arm 14. The base 12 is arranged and configured with a docking station well 18 for releasably retaining a portable electronic device 20 shown in phantom view. The docking well 18 may be suitably designed and configured with grooves or indentations to specifically fit a given portable electronic device such that the docking well may accommodate many different brands and sizes of portable electronic devices.

The arm 14 is arranged for articulated movement as shown by the direction arrow 42 about the pivot axis 22. A suitable tightening and loosening mechanism 26 is utilized to control the articulated movement of the arm 14 about the pivot axis 22 allowing the arm to rotate toward and away from the plane of a surface upon which the base 12 rests when loosened and to hold the arm in position when tightened.

The illumination source or lamps 16, 16 is arranged for articulated movement with respect to the arm 14 in the direction as indicated by arrow 44 about the pivot axis 24 in a direction toward and away from the arm 14 such that the end region 46 of the lamps 16, 16 follows along an arcuate path as indicated by the direction arrow 48. A suitable tightening and loosening mechanism 28 is utilized to control the articulated movement of the lamps 16, 16 about the pivot axis 24 in the vertical plane allowing the lamps 16, 16 to rotate toward and away from the arm 14 when loosened and to hold the lamps in position when tightened.

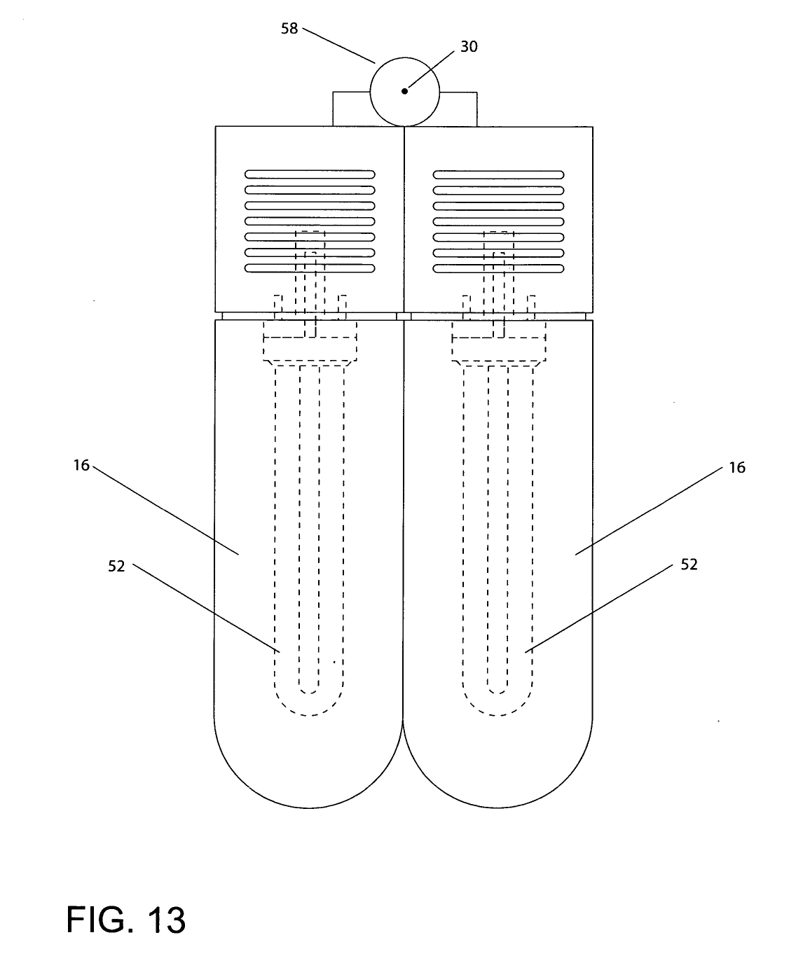

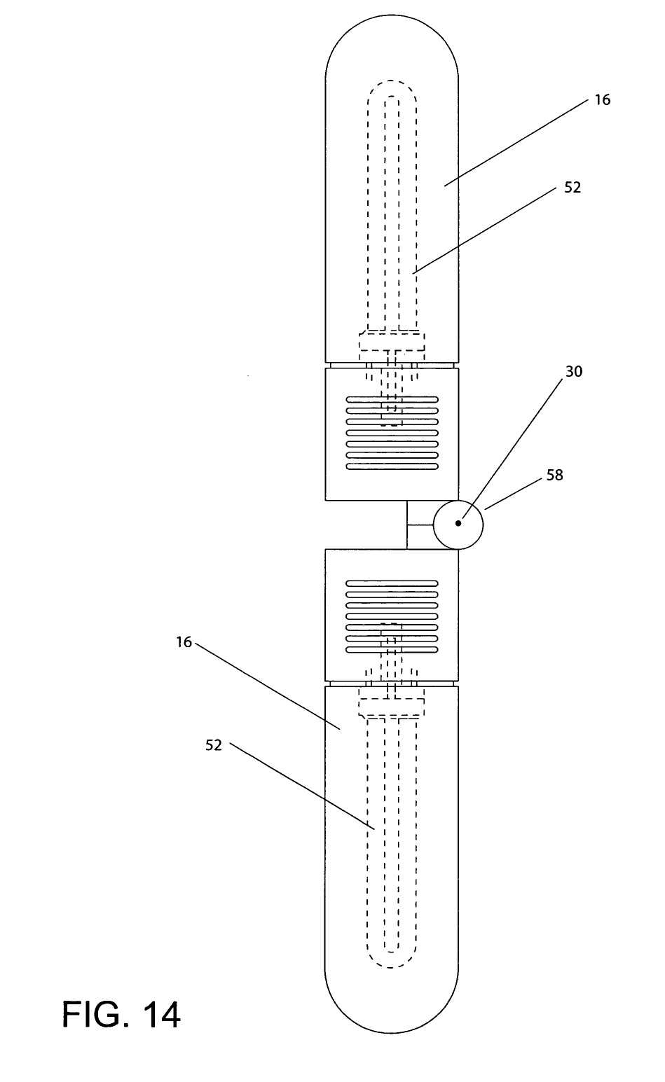

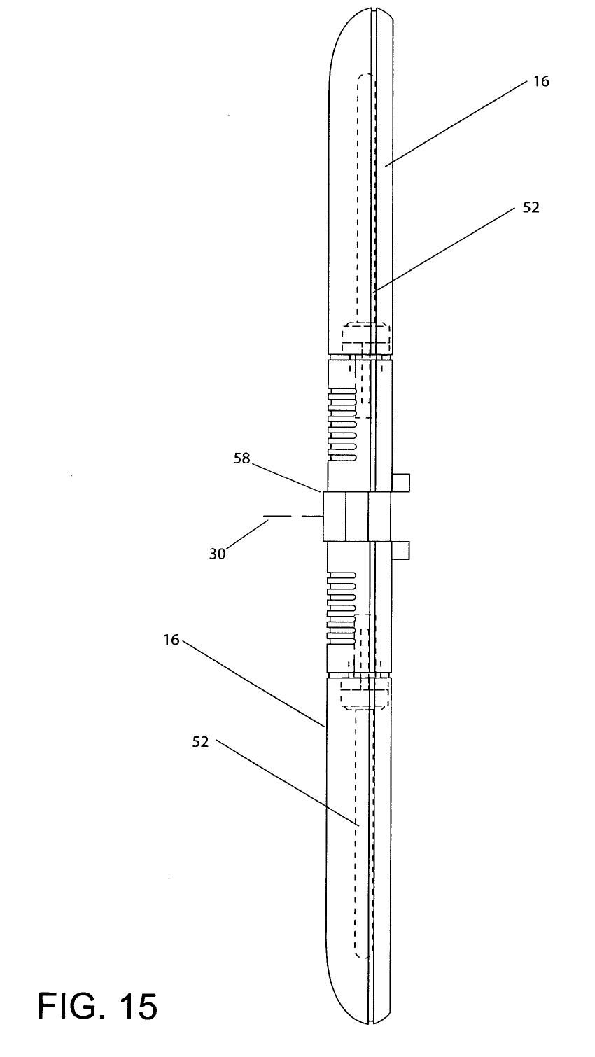

The lamps 16, 16 are also rotatable in the horizontal plane about a pivot axis 30 as best viewed in FIGS. 13, 14 and 15. A tightening/loosening mechanism 58 similar to the tightening and loosening mechanisms 26 and 28 is used to allow the movement of the lamps 16 with respect to one another about the pivot axis 30 when loosened and to hold the lamps in position when tightened.

The lamps 16, 16 are also suitably arranged and configured for limited rotational movement about the pivot axis 54 and are tiltable in a direction indicated by the direction arrow 56. A frictional coupling mechanism well known to those skilled in the art is used to allow restrained tilting of the lamps as desired.

It will be recognized that the combination of coordinated movements about the pivot axis 22, the pivot axis 24, the pivot axis 30 and the pivot axis 54 allows positioning the lamps 16, 16 to direct the illumination to an adjustable X-Y coordinate surface area and in a desired illumination pattern on a surface upon which the base 12 rests.

The docking station lamp 10 is arranged with a power cord generally designated 50 for connection to a source of a commercial electrical power such as a 110 volt AC outlet. The docking station lamp is suitably wired to provide the necessary electrical power to one or more bulbs 52, 52 carried by the lamp 16. The bulbs 52 are turned on and off by means of an on-off power switch 40 located on the base 12. The bulb 52 preferably provides daylight and in particular is a full spectrum light certified full spectrum bulb such as the certified full spectrum bulbs available from Blackstone International LTD., the assignee of the present invention. As shown, the docking station lamp 10 is equipped with two 13-watt certified full spectrum bulbs.

The on-off power switch 40 may be of any suitable design to carry out the intended function, however, it is contemplated that the on-off power switch 40 is a touch-sensitive switch that is back-lit with an LED lamp to allow a user to easily find the power switch in a reduced light environment. The LED light may be of any suitable color for example to harmonize with the color of the docking station lamp 10 itself.

The docking station lamp 10 includes a commercial electrical voltage outlet 32 at the rear of the base 12 into which a charging module 34 for the portable electronic device is plugged. The charging module 34 includes a charging cord 36 and a suitably configured charging cord plug 38 compatible with the portable electronic device 20 with which it is used. The configuration of the commercial electrical voltage outlet 32 is selected in accordance with the electrical plug connection configuration of the region in which the docking station lamp 10 is used.

The charging module 34 may be a universal charging module with interchangeable plugs 38 to accommodate different models and brands portable electronic devices, a charging module that is provided with the portable electronic device, or may be for example a proprietary charging module with a proprietary charging cord plug for operative connection via a proprietary configured connector arranged with the portable electronic device.

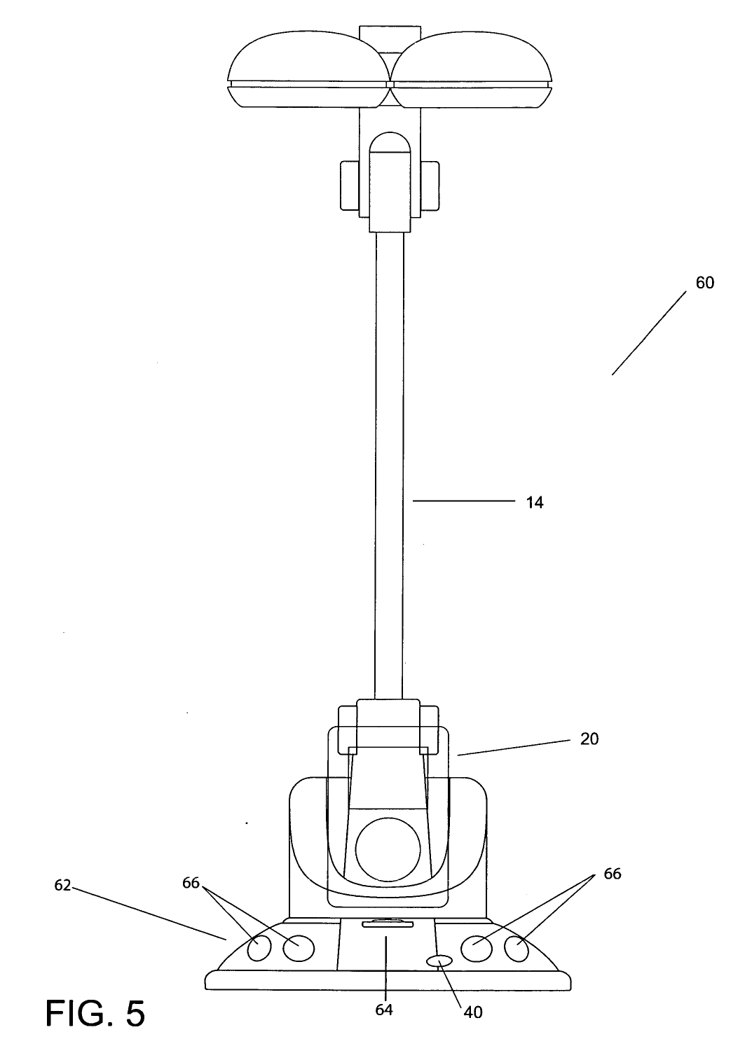

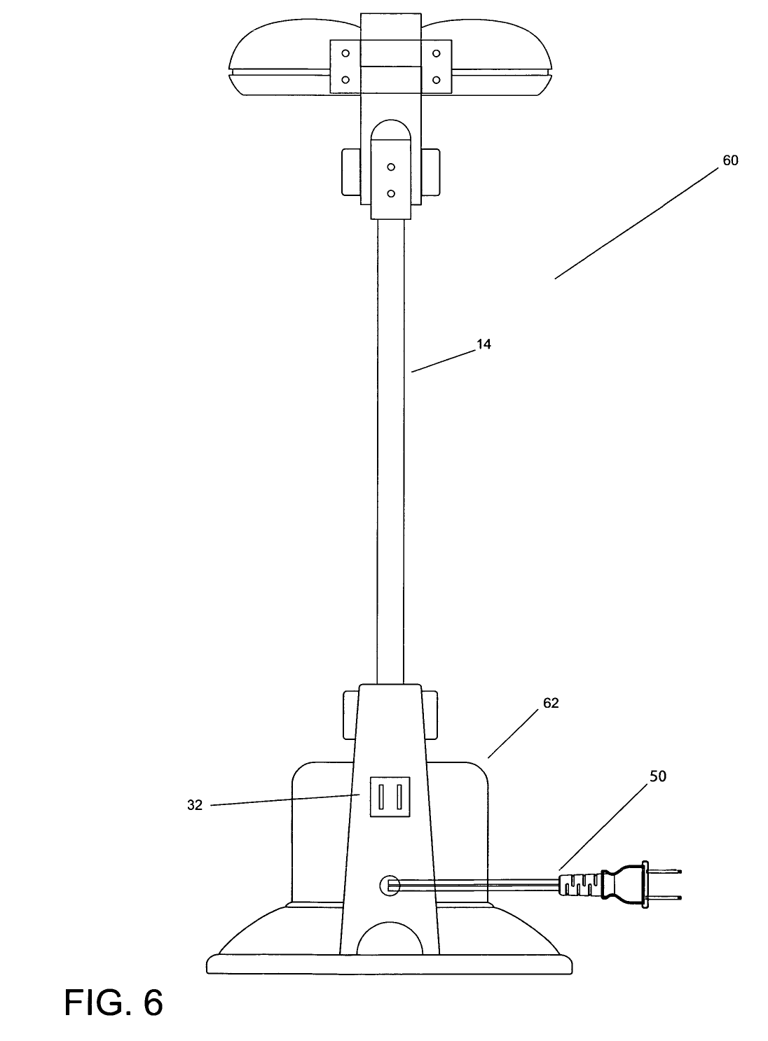

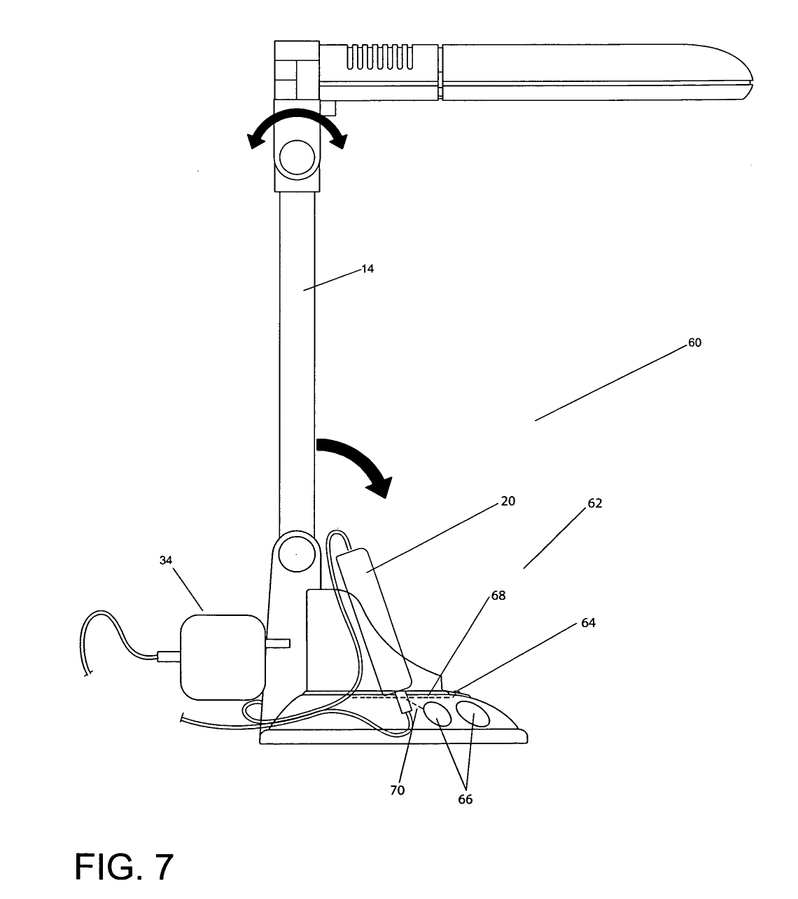

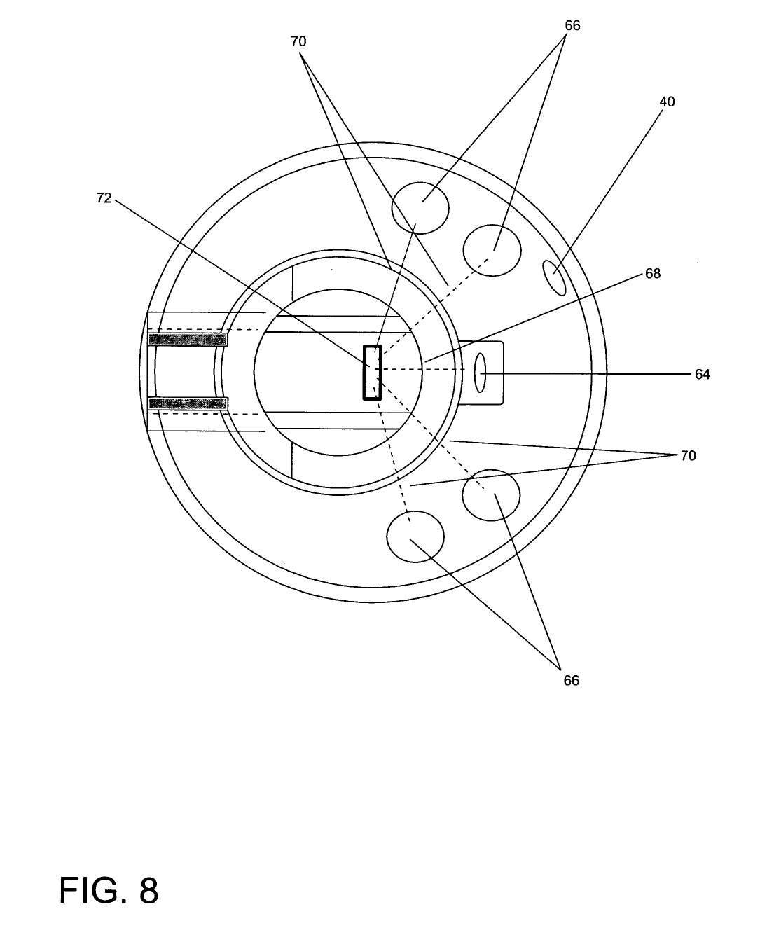

Referring now to FIGS. 5-8, another example of the docking station lamp embodying the invention is shown therein and generally designated 60. The docking station lamp 60 shown is similar to the docking station lamp 10 and like reference numerals identify similar like parts. The docking station lamp 60 includes a base 62 configured somewhat differently than the base 12 of the docking station lamp 10. The base 62 is configured with a microphone 64 and one or more speakers 66, 66. The microphone 64 and speakers 66, 66 are operatively connected to a portable electronic device releasably retained in the docking station well 18 by means of a suitably configured media cable having a suitable wiring 68 from the microphone 64 and suitable wiring 70 from the speaker 66 terminating in a suitable configured connector core plug 72 in the docking station well 18 for connection to a corresponding portable electronic device releasably retained in the docking station. The media cable may include a standard universal 3.5 mm headphone jack that allows for music or audio from any device to be played over the speakers 66. The media cable may also include a second input suitably configured with a plug such that the cable is plugged for example into the headset jack of a cellular telephone which is a standard 2.5 mm headset-3 pole jack. The voice is played over the speakers 66 while the microphone of the cellular telephone will pick up the voice of the user so that the docking station lamp functions as a speaker phone when a cellular telephone is releasably retained in the docking station well 18.

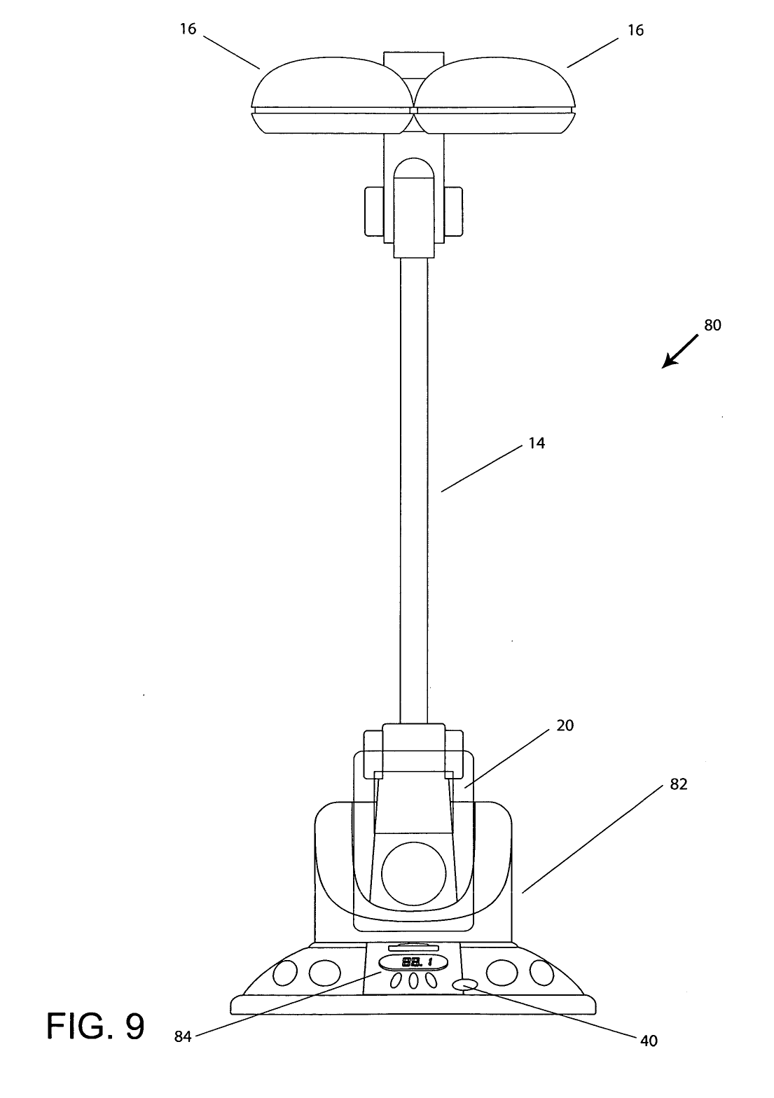

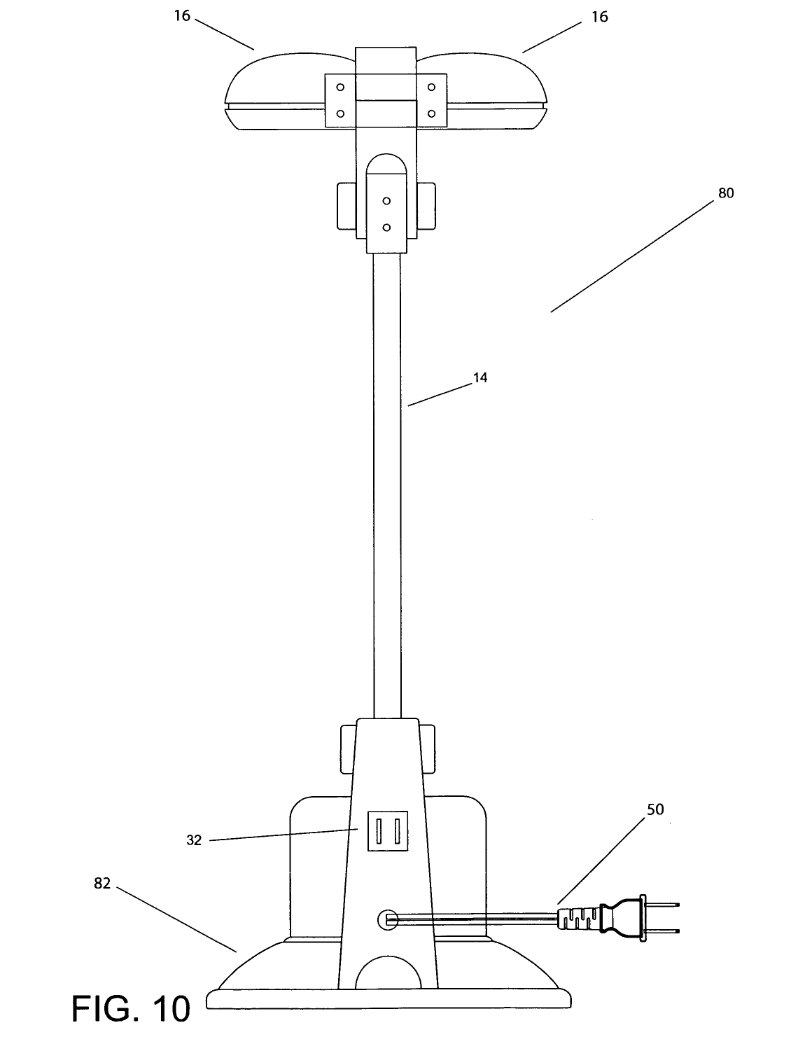

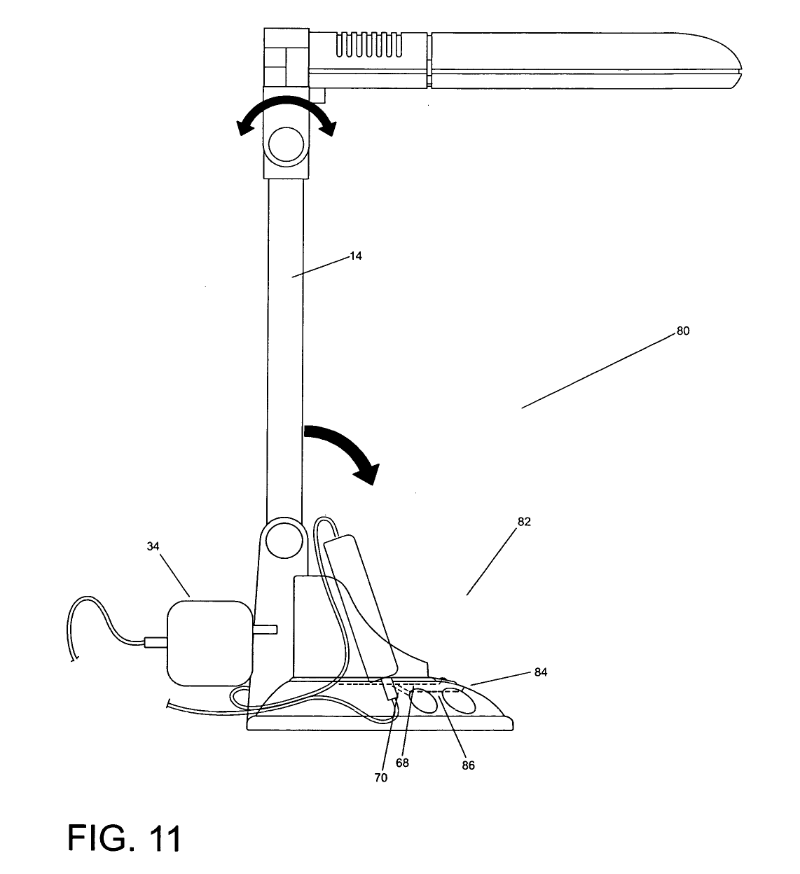

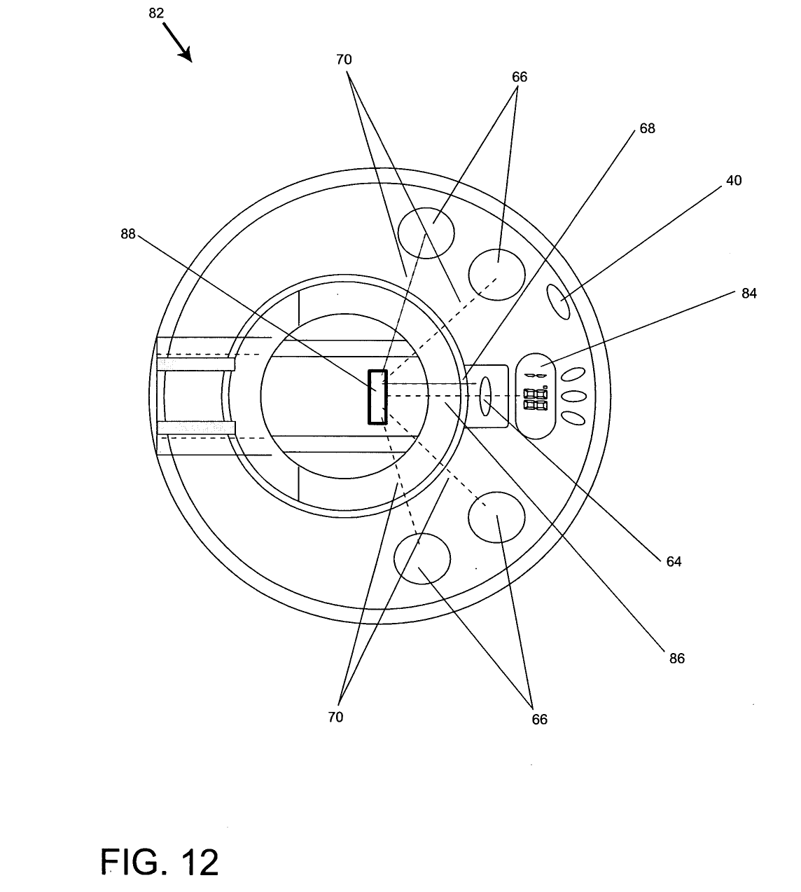

Now turning to FIGS. 9-12, a further example of the docking station lamp embodying the invention is shown therein and generally designated 80. The docking station lamp 80 is similar to the docking station lamp 10 for FIGS. 1-4 and docking station lamp 60 of FIGS. 5-8 and similar reference numerals identify similar like parts. The docking station lamp 80 includes a base 82 configured with a suitable FM transmitter 84 which is operatively connected to a portable electronic device 20 releasably retained in the docking station well 18 by means of a suitable media cable 86 to receive an electrical signal representative of audio or music from the portable electronic device such as a music player or MP3 player for example, for transmission to and reception by a remotely located FM receiver. The media cable wiring from the FM transmitter 84, microphone 64, and speakers 66 are suitably terminated in a connector 88 conformable with the portable electronic device releasably retained in the docking station well. For example, a docked media player such as an MP3 player can provide streaming music to a suitably arranged stereo system via the FM transmitter. The transmission of audio signals such as from a radio or other electronic device for reception by a suitably configured FM receiver for playing on a stereo system is well known to those skilled in the art.

It is to be understood that the connector at the docking station may be usable only with a specific portable electronic device such as for example, an Apple iPod®, which requires a proprietary 30 pin connector which allows the user to directly dock the iPod® in the docking station well to permit charging the iPod® while playing music over the speakers of the docking station lamp.

In a further example, the docking station lamp may incorporate a standard AM/FM radio for listening to radio station broadcasts over the speakers of the docking station lamp when the speakers are not in use with a media player or portable electronic device releasably retained in the docking station well.

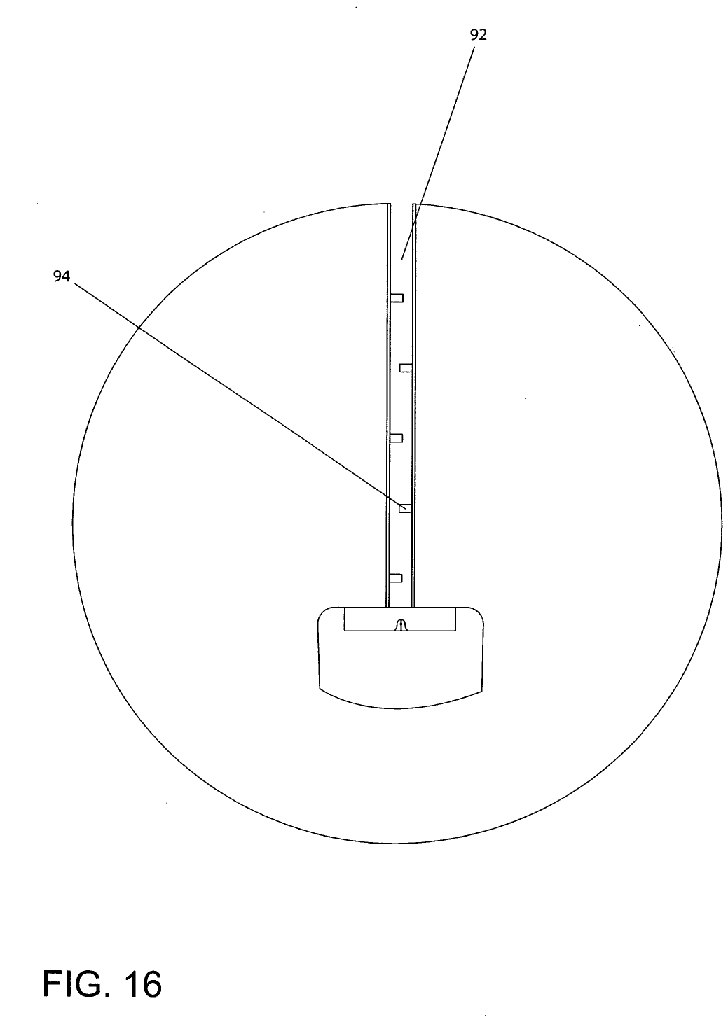

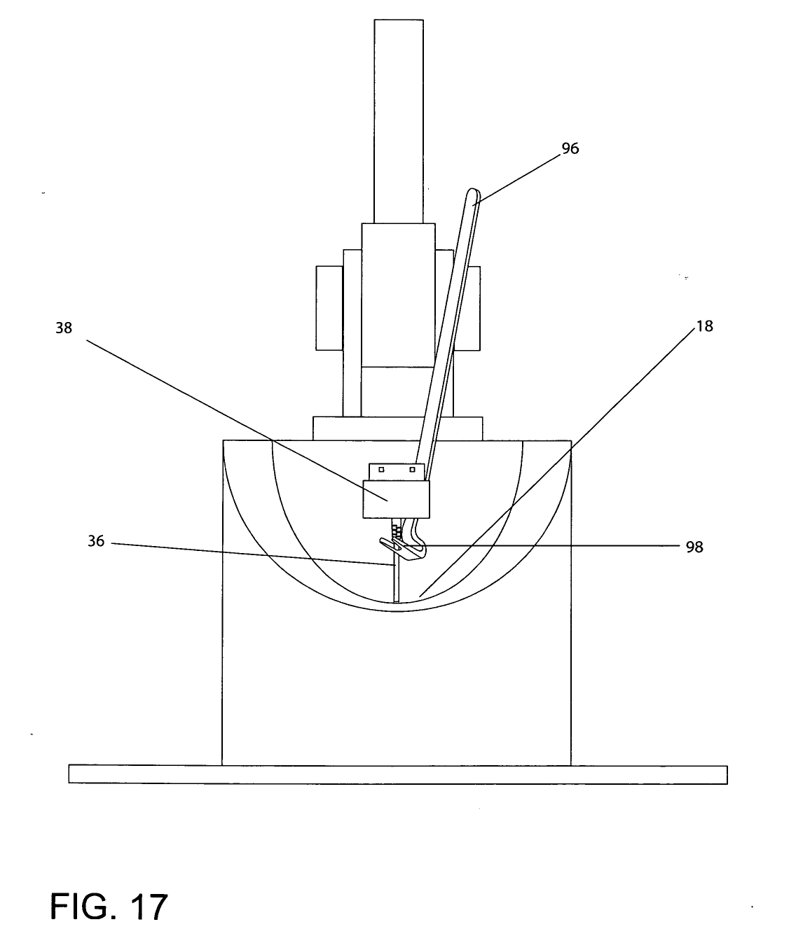

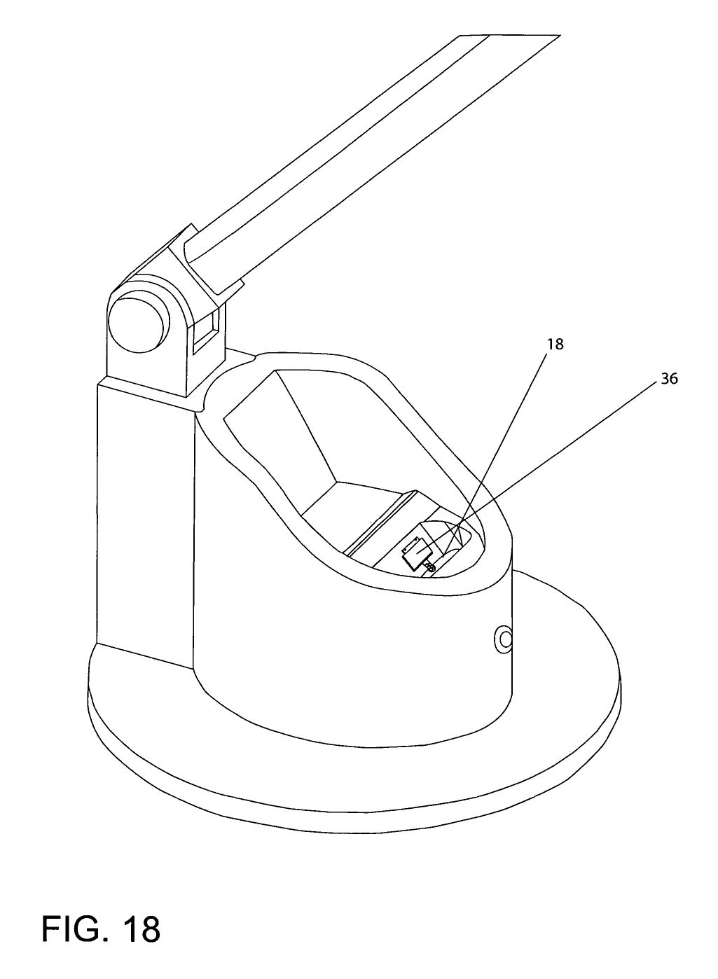

Turning now to FIG. 16, the underside of the base of the docking station lamp described above is shown therein revealing a groove 92 along which a charging cord 36 is snaked so that the plug end 38 of the charging cord can be passed through the opening 94 into the well of the docking station as described above. With reference to FIG. 17, a tool 96 is configured at one end 98 to grip or otherwise grab the charging cord plug end 38 to assist in positioning the plug in the well 18 of the docking station such as shown for example somewhat schematically in FIG. 18. The charging cord 36 may be held in the groove 92 and in place by way of small tabs in the underside of the groove and a silicon rubber flap.

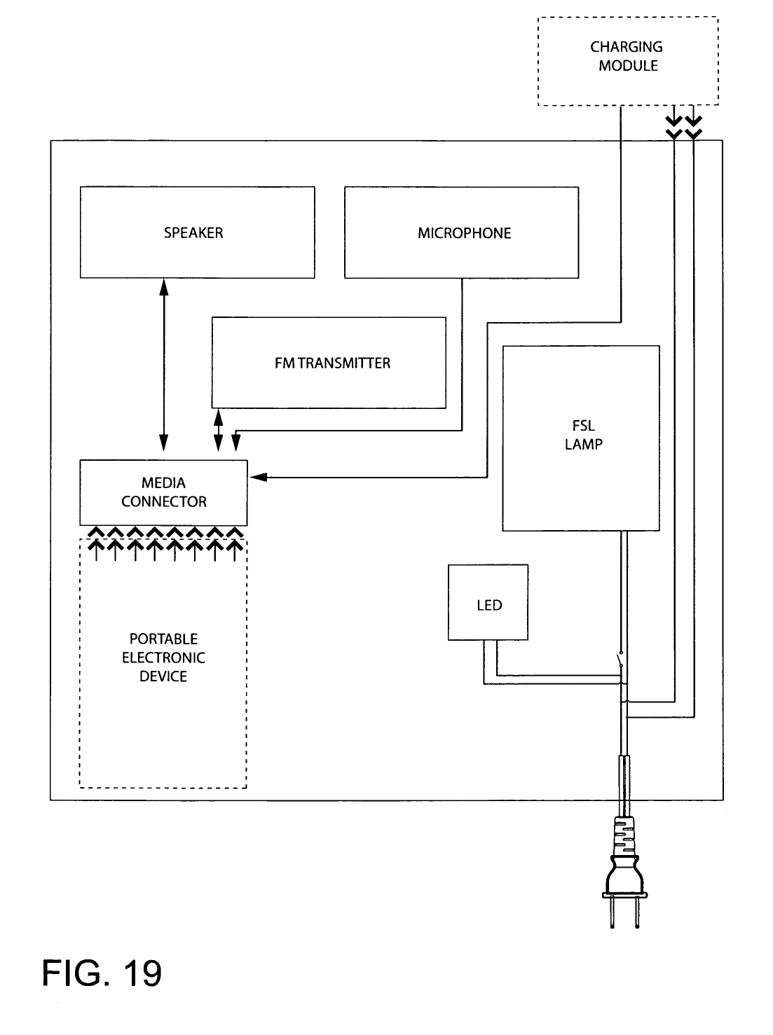

FIG. 19 is a schematic block diagram showing the interconnection between the major functional components of one example of the docking station lamp embodying the present invention for purposes of illustrating one way that the docking station lamp may be suitably wired for operation as described above.

A docking station lamp for charging battery operated portable electronic devices has been described above in several examples. It is understood that there may be many variations to the invention without departing from the spirit and scope of the invention. According the invention is described above by way of example and not limitation.

The invention claimed:

1. Apparatus, comprising:
a lamp arranged with:
a base;
an arm extending upwardly from said base;
at least one illumination source held by said arm;
said base further arranged and configured with a well as a docking station for releasably retaining a portable electronic device.

2. The apparatus as defined in claim 1 wherein said docking station is further configured with a suitable electrical charging module for an associated portable electronic device.

3. The apparatus as defined in claim 1 wherein said at least one illumination source is configured as a full spectrum lamp.

4. The apparatus as defined in claim 1 wherein said arm and said at least one illumination source are arranged for articulated motion with respect to said base and one another, such that the orientation of said at least one illumination source is configured for adjustable alignment with respect to a surface upon which the base rests.

5. The apparatus as defined in claim 1 wherein said base is further configured with at least one audio speaker for operative connection to an audio output of a portable electronic device releasably retained in said docking station well.

6. The apparatus as defined in claim 1 wherein said base is further configured with a microphone for operative connection to an audio input of a portable electronic device releasably retained in said docking station well.

7. The apparatus as defined in claims 1 wherein said base is further configured with a microphone for operative connection to an audio input of a portable electronic device and with at least one audio speaker for operative connection to an audio output of a portable electronic device releasably retained in said docking station well.

8. The apparatus as defined in claim 1 wherein said portable electronic device is configured as one of a cellular telephone, a PDA, a music player, a media player.

9. The apparatus as defined in claim 1 wherein said base is further configured with a suitable FM transmitter operatively connected to a portable electronic device releasably retained in said docking station well for broadcasting an FM signal to an external FM receiver unit.

10. The apparatus as defined in claim 1 further arranged for electrically connecting the lamp to a source of commercial AC electrical power.

11. The apparatus as defined in claim 10 said base is configured with a suitable AC electrical outlet for making the source of commercial AC electrical power available for access and use.

12. The apparatus as defined in claim 2 wherein the suitable electrical charging module is an electrical charging module supplied with the portable electronic device.

13. The apparatus as defined in claim 1 further configured with an adapter conforming to the portable electronic device for accommodating docking the portable electronic device in said docking station well.

14. The apparatus as defined in claim 12 wherein said base is further configured for accepting a charging plug of the electrical charging module.

15. The apparatus as defined in claim 13 further configured with a tool for feeding and locating the charging plug in said base.

16. The apparatus as defined in claim 1 wherein said docking station well is further arranged with an upwardly open well suitably dimensioned and shaped and configured for receiving a correspondingly shaped and dimensioned portable electronic device.

17. The apparatus as defined in claim 1 wherein said docking station is further configured for releasably retaining the portable electronic device in an operative condition.

18. Apparatus, comprising:
docking station means for releasably retaining a battery operated portable electronic device in a docking station well arranged in the base of a full spectrum lamp for charging the portable electronic device, and
a suitable connector means arranged in the docking station well for operatively connecting the portable electronic device to charging means for charging the portable electronic device.

19. System, comprising:
a docking station lamp having a base, a full spectrum lamp arranged and configured for adjustable positioning by an arm extending upwardly from a base;
a docking well arranged in said base for releasably retaining a battery operated portable electronic device for operative connection to a charging module for charging the portable electronic device, to a microphone and a speaker arranged in the base;
a commercial electrical power outlet arranged in the base for receiving the charging module; and
a power switch arranged in the base for turning power on and off to light and extinguish the full spectrum light bulb.
